(19) United States
(12) Patent Application Publication
(10) Pub. No.: US 2023/0095596 A1
(43) Pub. Date: Mar. 30, 2023

(54) GROUP MANAGEMENT APPARATUS, GROUP MANAGEMENT METHOD, AND COMPUTER READABLE MEDIUM

(71) Applicant: NEC Corporation, Minato-ku, Tokyo (JP)

(72) Inventor: Hiroshi TSUKADA, Tokyo (JP)

(73) Assignee: NEC Corporation, Minato-ku, Tokyo (JP)

(21) Appl. No.: 17/908,591

(22) PCT Filed: Mar. 10, 2020
(86) PCT No.: PCT/JP2020/010243

§ 371 Date: Sep. 1, 2022

(51) Int. Cl. G06F 21/31

(52) U.S. Cl. CPC G06F 21/31

(57) ABSTRACT

To provide a group management apparatus capable of appropriately determining whether to allow a user to join a group. A group management apparatus (100) according to the present disclosure includes: an authentication unit (1) configured to determine a result of identity authentication of a user; an acquisition unit (3) configured to acquire an activity history of the user from a blockchain where the activity history of the user being authenticated is saved; a determination unit (2) configured to make determination regarding whether to allow the user to join a group based on the acquired activity history; and a recording unit (4) configured to record a result of the determination in the blockchain.

### TECHNICAL FIELD

The present disclosure relates to a group management apparatus, a group management method, and a program.

### BACKGROUND ART

Recently, a blockchain has been known as a technology for implementing a highly reliable distributed ledger. The blockchain is also used in the field of computer user management.

For example, Patent Literature 1 discloses an information processing apparatus capable of recording a learning history of a user in a blockchain and, based on the record, determining the usefulness of webpages viewed by the user.

Furthermore, Patent Literature 2 discloses a computer system that saves information on the user's right to use content items in a blockchain, and performs digital rights management.

Furthermore, recently, also known is a technology that, when a new user wants to join a user group composed of a plurality of users, determines whether to allow the user to join based on a specific criteria.

For example, Patent Literature 3 discloses a management apparatus that, when a user wants to participate in a chat, is capable of determining whether to allow the user who wants to participate in the chat while reflecting the intention of all users who are already participating in the chat.

### CITATION LIST

### Patent Literature

Patent Literature 1: International Patent Publication No. WO 2019/111510

Patent Literature 2: Published Japanese Translation of PCT International Publication for Patent Application, No. 2019-532603

Patent Literature 3: Japanese Unexamined Patent Application Publication No.

### SUMMARY OF INVENTION

### Technical Problem

When a user wants to join a group anew, there are following problems in terms of user management.

First, it is not possible to determine whether the user who wants to join the group is actually that user. For example, even when the user applying to join the group claims that “the applicant is user A”, it is not possible to determine whether the user is truly the user A or another user pretending as the user A.

Furthermore, there is no criteria for determining whether the user is a user that can be allowed to join the group. For example, in the case of the chat described above, the user who wants to participate may be a user who is refused to participate from a plurality of chat groups. In that case, it is preferable in terms of a group management operation to set a certain criteria for making determination regarding whether to allow the user to participate rather than accepting participation of such a user unconditionally.

However, even if the determination criteria is set based on the activity history of the user, for example, there is no guarantee that the activity history is correct information without being tampered.

In Patent Literatures 1 to 3, there is no disclosure mentioned related to the aforementioned problems.

An object of the present disclosure, which has been made to overcome such problems, is to provide a group management apparatus, a group management method, and a program capable of appropriately determining whether to allow a user to join a group.

### Solution to Problem

The group management apparatus according to the present disclosure includes: an authentication unit configured to determine a result of identity authentication of a user; an acquisition unit configured to acquire an activity history of the user from a blockchain where the activity history of the user being authenticated is saved; a determination unit configured to make determination regarding whether to allow the user to join a group based on the acquired activity history; and a recording unit configured to record a result of the determination in the blockchain.

The group management method according to the present disclosure executed in a group management apparatus, the group management apparatus includes: determining a result of identity authentication of a user; acquiring an activity history of the user from a blockchain where the activity history of the user being authenticated is saved; making determination regarding whether to allow the user to join a group based on the acquired activity history; and recording a result of the determination in the blockchain.

The program according to the present disclosure is for causing a computer to execute a group management method including: determining a result of identity authentication of a user; acquiring an activity history of the user from a blockchain where the activity history of the user being authenticated is saved; making determination regarding whether to allow the user to join a group based on the acquired activity history; and recording a result of the determination in the blockchain.

### Advantageous Effects of Invention

According to the present disclosure, it is possible to provide the group management apparatus, the group management method, and the program capable of appropriately determining whether to allow a user to join a group.

### BRIEF DESCRIPTION OF DRAWINGS

FIG. 1 is a block diagram illustrating a configuration of a group management apparatus according to a first example embodiment;

FIG. 2 is a block diagram illustrating a configuration of a group management system including the group management apparatus according to a second example embodiment;

FIG. 3 is an explanatory diagram of a block of the group management system according to the second example embodiment;

FIG. 4 is a diagram illustrating an example of activity data of the group management system according to the second example embodiment;

FIG. 5 is a diagram illustrating examples of activity codes of the group management system according to the second example embodiment;

FIG. 6 is a diagram for describing an authentication method of the group management system according to the second example embodiment;

FIG. 7 is a flowchart illustrating processing of the group management apparatus according to the second example embodiment; and

FIG. 8 is a diagram illustrating an example of a hardware configuration of the group management apparatus according to the second example embodiment.

### EXAMPLE EMBODIMENT

### First Example Embodiment

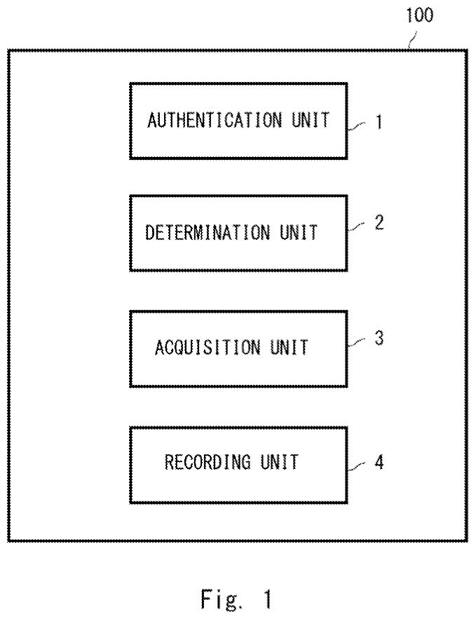

Hereinafter, a group management apparatus 100 according to a first example embodiment of the present disclosure will be described by referring to FIG. 1. The group management apparatus 100 includes an authentication unit 1, an acquisition unit 3, a determination unit 2, and a recording unit 4.

The authentication unit 1 determines a result of identity authentication of a user who is applying to join a group (referred to as “target user” hereinafter).

The acquisition unit 3 acquires an activity history of the target user from a blockchain in which the activity history of the user is saved.

The determination unit 2 determines whether to allow the target user to join the group based on the activity history of the target user acquired by the acquisition unit 3.

The recording unit 4 records the result of determination performed by the determination unit 2 in the blockchain.

As described above, with the group management apparatus according to the first example embodiment, it is possible to appropriately determine whether to allow the user to join the group.

### Second Example Embodiment

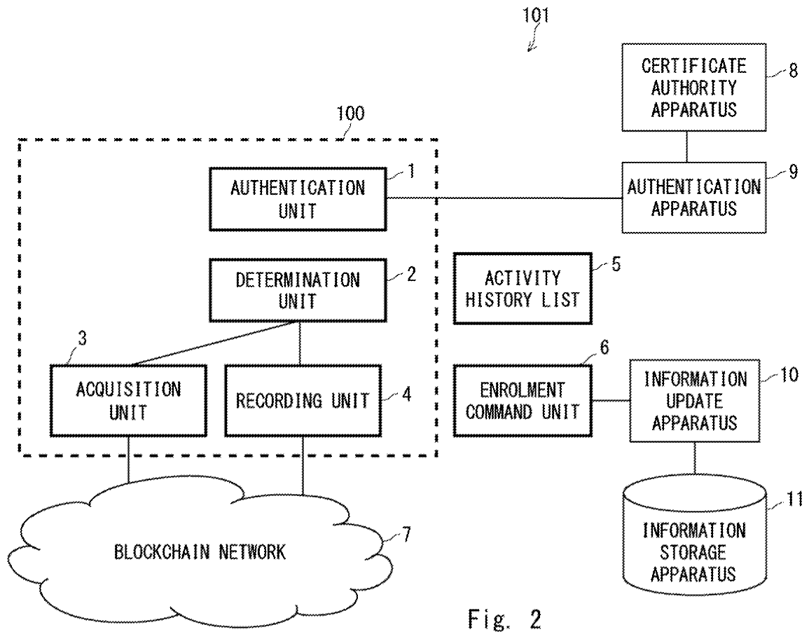

Referring to FIG. 2, a group management system according to a second example embodiment will be described. FIG. 2 is a block diagram illustrating a configuration of a group management system 101 including the group management apparatus 100 according to the second example embodiment.

The group management system 101 includes the group management apparatus 100, an activity history list 5, a blockchain network 7, an enrolment command unit 6, an information update apparatus 10, an information storage apparatus 11, an authentication apparatus 9, and a certificate authority apparatus 8.

As described in the first example embodiment, the group management apparatus 100 includes the authentication unit 1, the acquisition unit 3, the determination unit 2, and the recording unit 4.

The authentication unit 1 determines the result of identity authentication performed on the target user by the authentication apparatus 9.

The acquisition unit 3 acquires the activity history list 5 of the target user from the blockchain in which the activity history of the user is saved.

The determination unit 2 determines whether to allow the target user to join the group based on the content of the activity history list 5 acquired by the acquisition unit 3. The determination unit 2 makes determination based on such a condition that “the target user is allowed to join the group, when the record of leaving groups within three days includes two activities or less in the past ten activities of the target user”, for example.

Furthermore, the determination unit 2 may make determination based not only on the content of the activity history list 5 but also the number of activities as the condition. For example, by making such determination that “joining the group is refused, when the number of activities of the target user included in the activity history list 5 is five activities or less”, it is possible to consider the target user with insufficient activity record to be a user of low credibility and to refuse the user to join the group.

The determination method described above is presented as an example only, and the determination unit 2 is also capable of making determination by freely setting the conditions using the activity contents, the number of activities, and the like of the target user included in the activity history list 5.

The recording unit 4 requests a node on the blockchain network 7 to record the result of determination performed by the determination unit 2.

The activity history list 5 is formed by extracting activities related to a group of specific users from the block recorded on the blockchain network 7 and listing those in a chronological order.

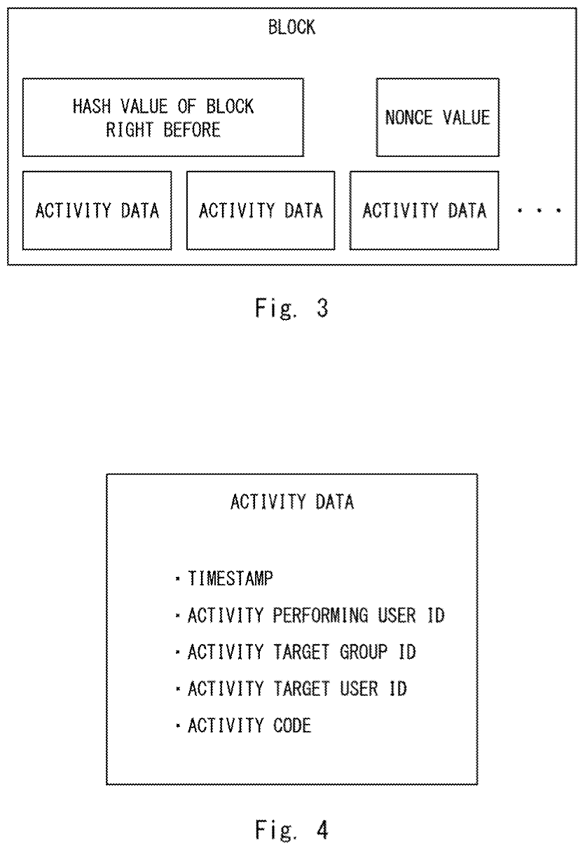

FIG. 3 illustrates an example of a block structure. The block includes activity data of the user, a hash value, and a nonce value. The hash value is a hash value of a block right before. A single block includes activity data of a single user. Also, a single block includes a plurality of pieces of activity data.

While transaction information is stored in a block in a technology related to virtual currency such as Bitcoin, activity data of the user is stored in the present disclosure instead of transaction information.

FIG. 4 illustrates an example of the content included in the activity data. As illustrated in FIG. 4, the activity data includes timestamp, activity performing user ID, activity target group ID, activity target user ID, and activity code.

The timestamp is the date and time of the user's activity. The activity performing user is the user whose activity is recorded. The activity target group is the group on which the activity performing user is to act, such as joining and leaving. The activity target user is a user who is to be allowed or refused to join the group by the activity performing user.

The activity performing user ID, the activity target group ID, and the activity target user ID are the values that identify and uniquely determine the activity performing user, the activity target group, and the activity target user, respectively. The activity code is the number uniquely given to the activity content of the user. These are examples of the contents included in the activity data, and contents other than those may also be included in the activity data.

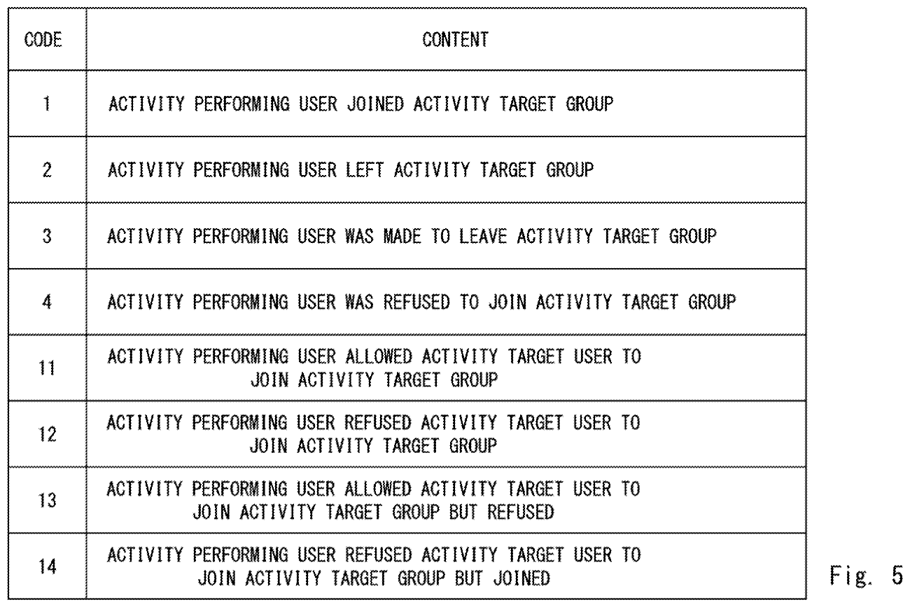

FIG. 5 illustrates examples of the activity codes. For example, the activity codes 1 to 4 correspond to the contents of the activities the activity performing user oneself performed for the activity target group.

For example, such an activity content that “the activity performing user joined the activity target group” corresponds to the activity code 1. Similarly, “the activity performing user left the activity target group” corresponds to the activity code 2. The activity contents include not only the activity performed by the activity performing user's own will but also the activity performed against the will of the activity performing user. For example, “the activity performing user was made to leave the activity target group” corresponds to the activity code 3.

Furthermore, the activity contents of the activity performing user performed for another user (the activity target user) correspond to the activity codes 11 to 14.

For example, cases where the activity performing user allows or refuses the activity target user to join the activity target group correspond to the activity codes 11 and 12. The activity contents also include the activity of the activity target user performed against the permission and refusal given by the activity performing user. For example, “the activity performing user allowed the activity target user to join the activity target group but refused” corresponds to the activity code 13.

These are examples of the activity codes, and it is also possible to set activity codes for contents other than those.

The blockchain network 7 is a network composed of a large number of computers and performs communication based on a blockchain algorithm. The blockchain network 7 generates a block as a unit of information, and connects such blocks like a chain to store information. The blocks are connected by being separated for each user.

The blockchain network 7 records activities of the user for the group. Not only that, the blockchain network 7 may also record other contents. For example, user's access to a prescribed folder, browsing of websites, and the like may be recorded.

When the determination unit 2 determines to allow the target user to join the group, the enrolment command unit 6 gives a command to the information update apparatus 10 to enroll the target user in the group.

The information update apparatus 10 updates the group information recorded in the information storage apparatus 11.

The information storage apparatus 11 stores the group information. The group information is the information regarding who the members of the group are.

The authentication apparatus 9 is an apparatus that checks whether the user is a true user. In the second example embodiment, authentication of the target user is performed by the public key cryptosystem.

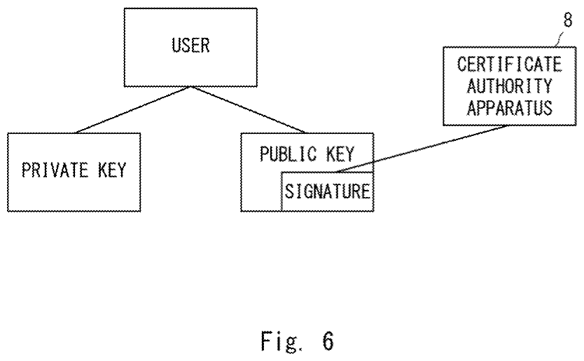

Referring to FIG. 6, the authentication method of the target user will be described. As illustrated in FIG. 6, all users have a public key and a private key. The public key has signature information by the certificate authority apparatus 8. The public key is disclosed to a terminal apparatus used by each user, and each user can freely acquire and use the public key. Meanwhile, the private key is managed by the user who owns the private key, and not disclosed to other users.

The authentication apparatus 9 guarantees that the public key is correct and to be of the user oneself based on the signature of the certificate authority apparatus 8 included in the public key. The authentication apparatus 9 guarantees that the user is the true user by using the public key, the private key, and encryption.

The certificate authority apparatus 8 is an apparatus that gives a signature to the public key of the user. The certificate authority apparatus 8 guarantees that the public key is the public key of the user. For example, even if a user B discloses a public key created by the user B by falsifying that it is a public key of a user A, other users and terminal apparatuses do not recognize the public key to be of the user A since the public key does not have a signature given by the certificate authority apparatus 8.

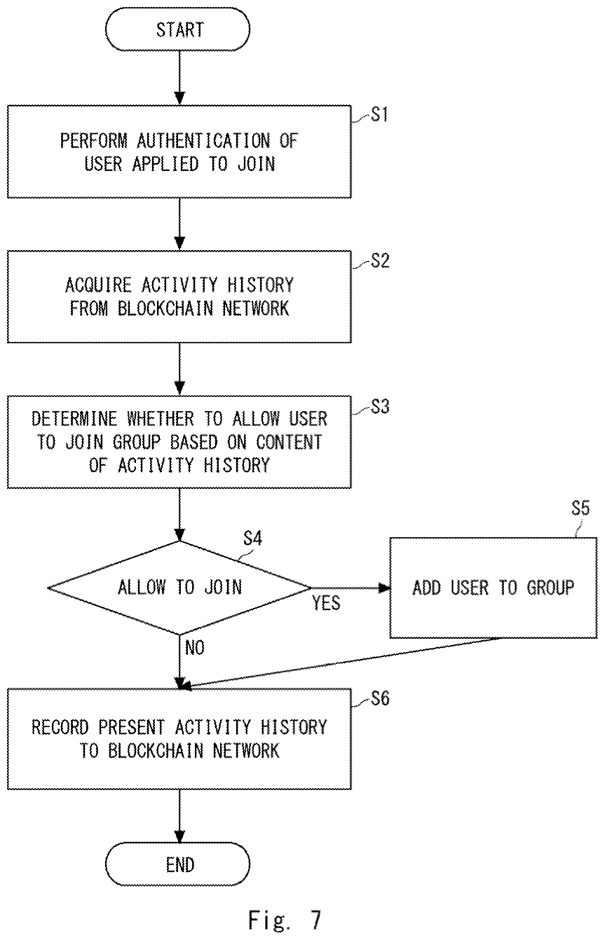

Subsequently, by referring to the flowchart illustrated in FIG. 7, processing executed by the group management apparatus 100 will be described. Herein, described is an operation of a case where a target user presents oneself as the user A and applies to join the group, and it is determined whether to allow the target user to join the group.

First, the group management apparatus 100 checks with the authentication unit 1 whether the target user applied to join the group is actually the user A (Step S1). The authentication unit 1 requests the authentication apparatus 9 to perform authentication of the target user.

At first, the authentication apparatus 9 generates a random character string. The authentication apparatus 9 encrypts the character string with the public key of the user A having the signature of the certificate authority apparatus 8, and gives it to the target user. The target user decrypts the encrypted character string using the own private key, and returns the character string acquired by decryption to the authentication apparatus 9.

When the returned character string matches the initially generated character string, the authentication apparatus 9 determines that the target user is the user A. Inversely, when the returned character string does not match the initially generated character string, the authentication apparatus 9 determines that the target user is not the user A.

The authentication unit 1 returns the determination result of the authentication apparatus 9 to the group management apparatus 100. The group management apparatus 100 proceeds to the subsequent processing when the returned determination result indicates that it is the user A, and refuses the target user to join the group when the determination result indicates that it is not the user A.

Then, the group management apparatus 100 acquires the activity history list 5 related to the user A from the blockchain network 7 by the acquisition unit 3 (Step S2).

The group management apparatus 100 gives the acquired activity history list 5 to the determination unit 2. The determination unit 2 determines whether the provided activity history list 5 of the user A satisfies the determination condition for allowing to join the group (Step S3). For example, it is supposed that the determination condition for allowing to join the group is “the record of leaving groups within three days includes two activities or less in the past ten activities of the activity history”. The determination unit 2 checks the past ten activities of the user A to see whether there are two activities or less of leaving the groups within three days after joining thereto.

The determination unit 2 determines to allow the target user to join the group when the activity history list 5 of the user A satisfies the determination condition for allowing to join the group, and determines not to allow the target user to join the group when not satisfying the determination condition (Step S4).

When the determination unit 2 determines to allow the target user to join the group (YES at Step S4), the group management apparatus 100 gives the information of the user A to the enrolment command unit 6. The enrolment command unit 6 uses the provided information of the user A to request the information update apparatus 10 to enroll the user A in the group (Step S5). The information update apparatus 10 updates the group information recorded in the information storage apparatus 11. Thereby, in the group information stored in the information storage apparatus 11, the user A is added as the member of the group.

The recording unit 4 converts the activity of the user A for the group in the processing into activity data to be connected to the activity history of the user A like beads, and records the activity data on the blockchain network 7 (Step S6). Specifically, the recording unit 4 requests a node on the blockchain network 7 to record the determination result of the determination unit 2.

When the user A as the target user joins the group, the recording unit 4 records an activity history indicating that “the user A joined the group” on the blockchain network 7. Furthermore, when the determination unit 2 determines not to allow the user A to join the group (NO at Step S4), the recording unit 4 records an activity history indicating that “the user A was refused to join the group” on the blockchain network 7 (Step S6).

As described above, with the group management system according to the example embodiment, it is possible to appropriately determine whether to allow the user to join the group. Furthermore, based on the determination, it is possible to allow the user to join the group and appropriately record the activity of the user.

Furthermore, with the group management method according to the example embodiment, it is possible to determine the result of identity authentication of the user, acquire the activity history of the user from the blockchain in which the activity history of the authenticated user is saved, determine whether to allow the user to join the group based on the acquired activity history, and record the determination result in the blockchain, thereby making it possible to appropriately determine whether to allow the user to join the group.

Example of Hardware Configuration

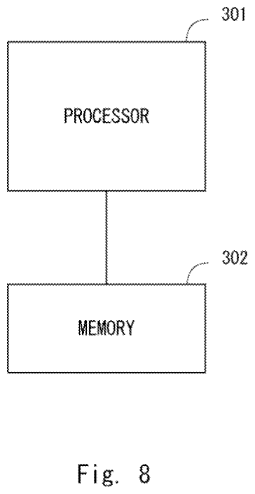

FIG. 8 is a block diagram illustrating an example of a hardware configuration for implementing group management processing. The hardware configuration includes a processor 301 and a memory 302.

The processor 301 performs the processing of the group management apparatus 100 described by using the flowchart in the example embodiment above by reading out and executing a computer program (group management program) from the memory 302. Note here that the group management program is for causing a computer to execute the group management method that determines the result of identity authentication of the user, acquires the activity history of the user from the blockchain in which the activity history of the authenticated user is saved, determines whether to allow the user to join the group based on the acquired activity history, and records the determination result in the blockchain.

The processor 301 may be a microprocessor, an MPU (Micro Processing Unit), or a CPU (Central Processing Unit), for example. The processor 301 may include a plurality of processors.

The memory 302 is composed of a combination of a volatile memory and a nonvolatile memory. The memory 302 may include a storage disposed away from the processor 301. In that case, the processor 301 may access the memory 302 via an I/O interface, not illustrated.

In the case of FIG. 8, the memory 302 is used for storing a software module group. The processor 301 can perform the processing of the group management apparatus 100 described in the example embodiment above by reading out and executing the software module group from the memory 302.

Each of the processors executes a single or a plurality of programs including a command group for causing the computer to perform the algorithm described by using the drawings. The program can be stored by using various types of non-transitory computer readable media and supplied to the computer.

The non-transitory computer readable media include various types of tangible storage media. Examples of the non-transitory computer readable media may be magnetic recording media (for example, a flexible disk, a magnetic tape, and a hard disk drive), a magneto-optical recording medium (for example, a magneto-optical disc), a Compact Disc Read Only Memory (CD-ROM), a CD-R, a CD-R/W, and semiconductor memories (for example, a mask ROM, a Programmable ROM (PROM), an Erasable PROM (EPROM), a flash ROM, and a Random Access Memory (RAM)). Furthermore, the program may be supplied to the computer via various types of transitory computer readable media. Examples of the transitory computer readable media include electrical signals, optical signals, and electromagnetic waves. The transitory computer readable media can supply the program to the computer via a wired communication path such as an electrical wire or an optical fiber or via a wireless communication path.

Note that the present disclosure is not limited by the example embodiments but may be changed as appropriate without departing from the scope thereof.

For example, not limited to the above case that is described regarding whether to allow a user to join a group, it is also possible to perform determination regarding whether to let a user who is already in a group leave the group.

Furthermore, while the determination unit 2 makes determination by directly using the contents and the number of activities in the activity history of the target user in the above case, the present disclosure is not limited thereto. The determination unit 2 may make determination by using those indirectly. For example, the credibility of the target user may be calculated from the activity history of the target user, and whether to allow the target user to join the group may be determined based on the credibility. Specifically, it is considered to set the points corresponding to the activities of the user such as “add 3 points when joined a group” and “deduct 1 point when left a group”, and calculate the total points to find the credibility of the user. In this case, the points may be added or deducted in accordance with the group joining period or the like. For example, it may be set as “1 more point is deducted when the user left the group within three days after joining the group”. This makes it possible to calculate low credibility for the user who leaves a group in a short period.

Furthermore, while whether to allow the target user to join is determined based on the activities of the target user for the group in the above case, it is also possible to include activities other than those performed for the group, such as accessing a prescribed folder and browsing websites, for example, for making determination. For example, when there is an activity history considered highly probable to be of the user A, such as “logged in a bank account in the name of the user A”, for example, it is considered that the credibility of the user is high and the user may be allowed to join the group.

Furthermore, while the public key cryptosystem is used for authentication of the users in the above case, other authentication methods may be used as well.

### REFERENCE SIGNS LIST

1 AUTHENTICATION UNIT
2 DETERMINATION UNIT
3 ACQUISITION UNIT
4 RECORDING UNIT
5 ACTIVITY HISTORY LIST
6 ENROLMENT COMMAND UNIT
7 BLOCKCHAIN NETWORK
8 CERTIFICATE AUTHORITY APPARATUS
9 AUTHENTICATION APPARATUS
10 INFORMATION UPDATE APPARATUS
11 INFORMATION STORAGE APPARATUS
100 GROUP MANAGEMENT APPARATUS
101 GROUP MANAGEMENT SYSTEM

What is claimed is:

1. A group management apparatus comprising:
at least one memory storing instructions, and
at least one processor configured to execute the instructions to;
determine a result of identity authentication of a user;
acquire an activity history of the user from a blockchain where the activity history of the user being authenticated is saved;
make determination regarding whether to allow the user to join a group based on the acquired activity history; and
record a result of the determination in the blockchain.

2. The group management apparatus according to claim 1, wherein the at least one processor is further configured to execute the instructions to enroll the user in the group based on the determination.

3. The group management apparatus according to claim 1, wherein the activity history includes at least one of:
an activity performing user ID for identifying an activity performing user as the user whose activity history is to be recorded;
an activity target group ID for identifying a group on which the activity performing user is to act;
an activity target user ID for identifying another user on which the activity performing user is to act; and
an activity code for identifying the activity of the activity performing user.

4. The group management apparatus according to claim 1, wherein the at least one processor is further configured to execute the instructions to calculate credibility of the user based on the activity history and make the determination based on the credibility.

5. The group management apparatus according to claim 4, wherein the credibility is calculated based on a point set by corresponding to the activity.

6. A group management method executed in a group management apparatus, the group management apparatus comprising:
determining a result of identity authentication of a user;
acquiring an activity history of the user from a blockchain where the activity history of the user being authenticated is saved;
making determination regarding whether to allow the user to join a group based on the acquired activity history; and
recording a result of the determination in the blockchain.

7. A non-transitory computer readable medium storing a program for causing a computer to execute a group management method comprising:
determining a result of identity authentication of a user;
acquiring an activity history of the user from a blockchain where the activity history of the user being authenticated is saved;
making determination regarding whether to allow the user to join a group based on the acquired activity history; and
recording a result of the determination in the blockchain.
